(19) United States
(12) Patent Application Publication
(10) Pub. No.: US 2026/0309840 A1
(43) Pub. Date: Oct. 8, 2026

(54) RADAR COVER ATTACHMENT AND DETACHMENT STRUCTURE

(71) Applicant: Stanley Electric Co., Ltd., Tokyo (JP)

(72) Inventors: Ryota TADA, Tokyo (JP); Tatsuya OKADA, Tokyo (JP); Takehiro MATSUMOTO, Tokyo (JP)

(21) Appl. No.: 19/484,701

(22) PCT Filed: May 10, 2024
(86) PCT No.: PCT/JP2024/017337

§ 371 Date: Nov. 14, 2025

(30) Foreign Application Priority Data
May 18, 2023 (JP) 2023-082295

(51) Int. Cl. G01S 7/02; B60Q 1/00

(52) U.S. Cl. CPC G01S 7/027; B60Q 1/0023; B60Q 1/007

(57) ABSTRACT

To provide a radar cover attachment and detachment structure. A radar cover attachment and detachment structure for detachably attaching a radar cover to a bracket to which a radar unit is detachably attached, the radar cover attachment and detachment structure comprising: an engagement portion provided on one of the bracket and the radar cover, and an engaged portion provided on the other and with which the engagement portion engages, wherein the engagement portion engages with the engaged portion by sliding movement of the radar cover relative to the bracket, and wherein the radar cover is detachably attached to the bracket by the engagement portion engaging with the engaged portion.

This application is a U.S. National Stage Application under 35 U.S.C § 371 of International Patent Application No. PCT/JP 2024/017337 filed May 10, 2024, which claims the benefit of priority under 35 U.S.C. § 119 to Japanese Patent Application No. 2023-082295 filed May 18, 2023, the disclosures of all of which are hereby incorporated by reference in their entireties.

### TECHNICAL FIELD

The present disclosure relates to a radar cover attachment and detachment structure.

### BACKGROUND ART

A vehicular lamp is known, comprising: an outer lens including a recess in which a radar unit is mounted; and radar cover detachably attached to the outer lens so as to cover the recess. The radar unit is used to detect an object by transmitting high-frequency electromagnetic waves (e.g., millimeter waves) to an area around the vehicle and receiving reflected waves from an object present within a transmission range.

### CITATION LIST

### Patent Literature

Patent Literature 1: Japanese Unexamined Patent Application Publication No. 2021-091303

### SUMMARY OF INVENTION

### Technical Problem

However, Patent Document 1 contains no description at all regarding a radar cover attachment and detachment structure, and there is room for improvement in this respect.

The present disclosure has been made in order to solve such problems, and an object thereof is to provide a radar cover attachment and detachment structure.

### Solution to Problem

A radar cover attachment and detachment structure in which a radar cover is detachably attached to a bracket to which a radar unit is detachably attached, the radar cover attachment and detachment structure comprising: an engagement portion provided on one of the bracket and the radar cover; and an engaged portion provided on the other, with which the engagement portion engages, wherein the engagement portion engages with the engaged portion by sliding the radar cover with respect to the bracket, and wherein the radar cover is detachably attached to the bracket by the engagement portion engaging with the engaged portion.

With such a configuration, it is possible to provide a radar cover attachment and detachment structure. For example, by sliding the radar cover in one direction relative to the bracket, it is possible to provide a radar cover attachment and detachment structure in which the radar cover can be detachably attached to the bracket.

In addition, in the radar cover attachment and detachment structure, wherein the engagement portion may include a first engagement portion, the engaged portion may include a first engaged portion with which the first engagement portion engages, the first engagement portion may be provided on both sides in a sliding direction on one of the bracket and the radar cover, and the first engaged portion may be provided on both sides in the sliding direction on the other of the bracket and the radar cover corresponding to the first engagement portion.

In addition, in the radar cover attachment and detachment structure, wherein the engagement portion further may include a second engagement portion and a third engagement portion, the engaged portion further may include a second engaged portion with which the second engagement portion engages and a third engaged portion with which the third engagement portion engages, the second engagement portion may be provided on a tip end side in a sliding direction on one of the bracket and the radar cover, the second engaged portion may be provided on a tip end side in the sliding direction on the other of the bracket and the radar cover corresponding to the second engagement portion, the third engagement portion may be provided on a base end side in the sliding direction on one of the bracket and the radar cover, and the third engaged portion may be provided on a base end side in the sliding direction on the other of the bracket and the radar cover corresponding to the third engagement portion.

In addition, in the radar cover attachment and detachment structure, wherein the bracket to which the radar unit and the radar cover are detachably attached may be detachably attached to a recess formed in an outer lens, and wherein a base end side in the sliding direction of the radar cover may be exposed from the recess and may be covered with a vehicle-side member.

In addition, in the radar cover attachment and detachment structure, wherein a tip end side in the sliding direction of the radar cover may be an upper end side of the radar cover, and wherein a base end side in the sliding direction of the radar cover may be a lower end side of the radar cover.

In addition, in the radar cover attachment and detachment structure, wherein the vehicle-side member may be a bumper.

### Advantageous Effects of Invention

According to the present disclosure, it is possible to provide a radar cover attachment and detachment structure.

### BRIEF DESCRIPTION OF DRAWINGS

FIG. 1 is a perspective view of the vicinity of the vehicular lamp 10 mounted on a vehicle;

FIG. 2 is a view as seen in the direction of arrow Arl in FIG. 1;

FIG. 3 is a top view (schematic view) of the vehicular lamp 10;

FIG. 4 is a sectional view taken along line IV-IV in FIG. 2;

FIG. 5 is an exploded perspective view of the vehicular lamp 10;

FIG. 6 is a front view of the radar cover 60 attached to the bracket 50;

FIG. 7 is an exploded perspective view of the bracket 50 and the radar cover 60; and

FIG. 8 is a perspective view showing a state in which the rear surface side of the radar cover 60 abuts against the front surface side of the bracket 50, and the intermediate engaged portion 63 of the radar cover 60 is positioned below the hook portion 54 of the bracket 50.

### DESCRIPTION OF EMBODIMENTS

Hereinafter, a vehicular lamp to which a radar cover attachment and detachment structure according to an embodiment of the present disclosure is applied will be described with reference to the accompanying drawings. In the drawings, corresponding components are denoted by the same reference numerals, and redundant descriptions are omitted.

The vehicular lamp 10 of the present embodiment is a vehicular lamp functioning as a headlamp, and is mounted on both left and right sides of a front end portion of a vehicle (not shown) such as an automobile. Since the vehicular lamps 10 mounted on the left and right sides have a symmetrical configuration, description will hereinafter be given, representatively, of the vehicular lamp 10 mounted on the left side (the left side as viewed from the front of the vehicle) of the front end portion of the vehicle.

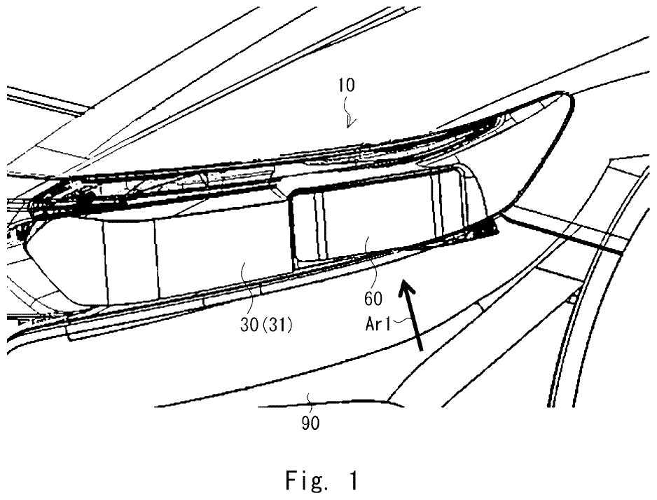

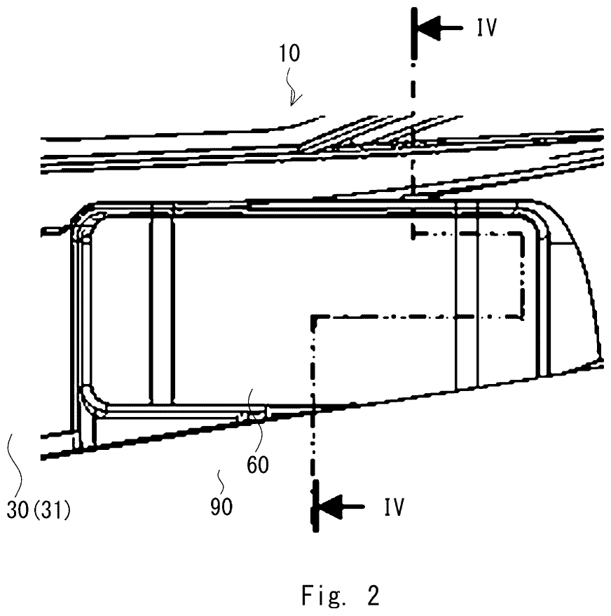

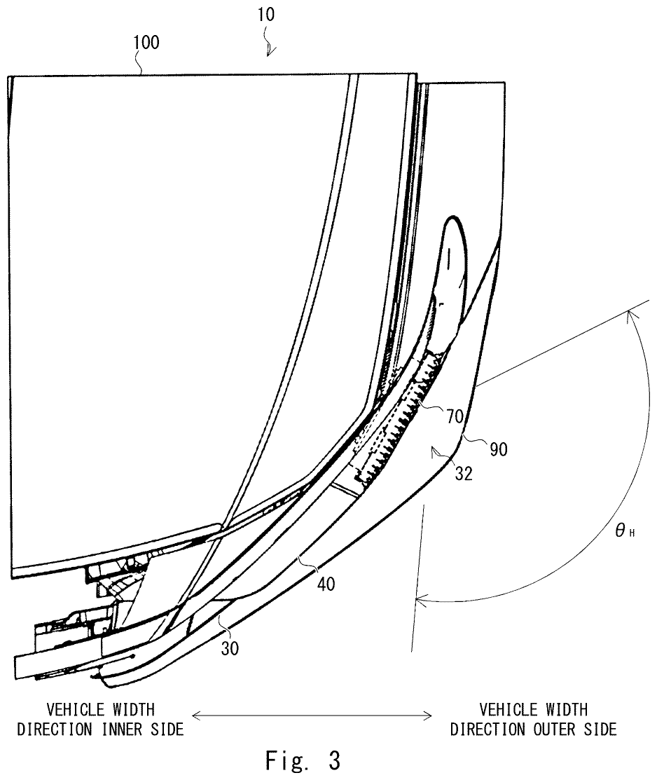

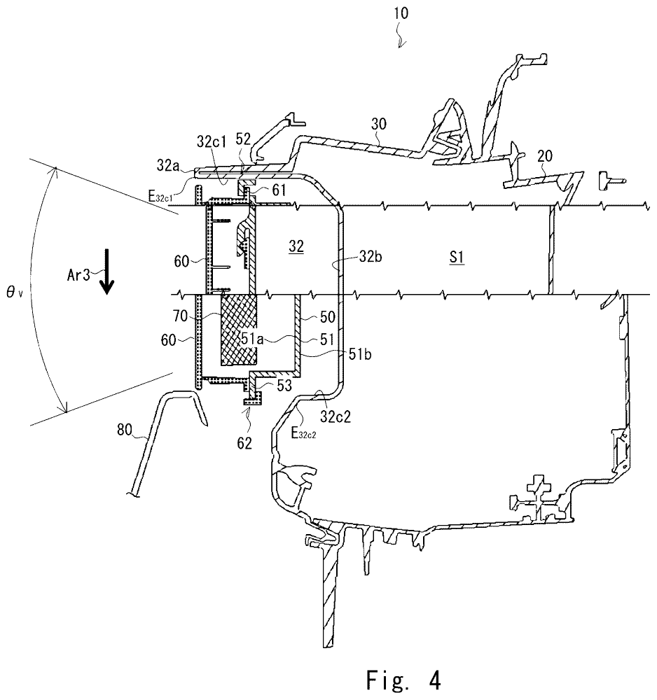

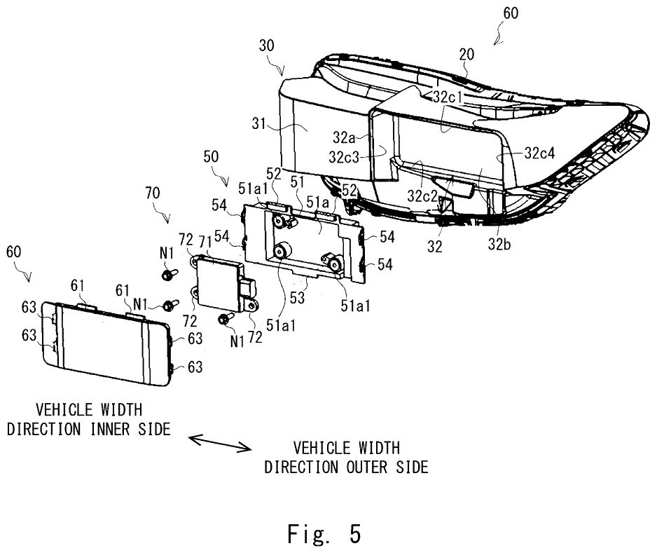

FIG. 1 is a perspective view of the vicinity of the vehicular lamp 10 mounted on a vehicle, FIG. 2 is a view as seen in the direction of arrow Ar1 in FIG. 1, FIG. 3 is a top view (schematic view) of the vehicular lamp 10, FIG. 4 is a sectional view taken along line IV-IV in FIG. 2, and FIG. 5 is an exploded perspective view of the vehicular lamp 10.

As shown in FIGS. 3 to 5, the vehicular lamp 10 includes a lamp housing 20, an outer lens 30, a lamp unit 40, a bracket 50, a radar cover 60, and a radar unit 70. It is to be noted that reference numeral 100 in FIG. 3 denotes a vehicle body.

The outer lens 30 is attached to the lamp housing 20 so as to define a lamp chamber S1 (see FIG. 4, etc.) between the outer lens 30 and the lamp housing 20.

Although not shown, a lamp unit 40 is disposed in the lamp chamber S1. The lamp unit 40 may have any configuration as long as it is a lamp unit that emits light functioning as a headlamp. For example, the lamp unit 40 may be a projector-type lamp unit, a reflector-type lamp unit, a direct projection-type lamp unit, or a lamp unit using a light guide (light guide rod, light guide plate), or may be another type of lamp unit.

The outer lens 30 is made of a transparent resin (synthetic resin) such as acrylic or polycarbonate, and includes a lens portion 31 through which light emitted from the lamp unit 40 passes, and a recess 32 recessed from a front side toward a rear side (lamp housing 20 side). The lens portion 31 is disposed on an inner side in a vehicle width direction, and the recess 32 is disposed on an outer side in the vehicle width direction.

The recess 32 is constituted by a front-side opening end portion 32a, a rear-side bottom portion 32b, and an inner wall 32c (an upper inner wall 32cl, a lower inner wall 32c2, an inner-side inner wall 32c3, and an outer-side inner wall 32c4) between the opening end portion 32a and the bottom portion 32b.

A bracket 50 is detachably attached to the outer lens 30 (the recess 32) having the above configuration.

Next, the bracket 50 will be described.

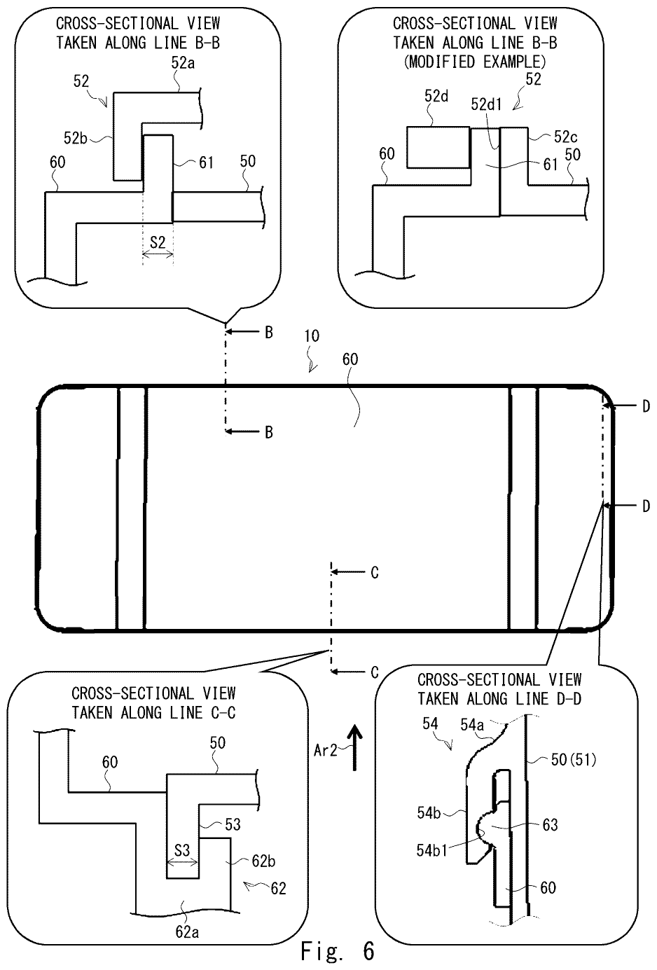

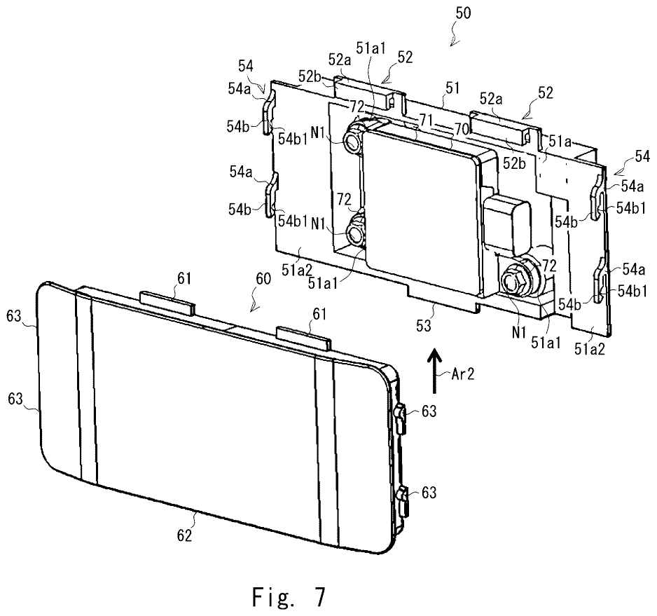

FIG. 6 is a front view of the radar cover 60 attached to the bracket 50, and FIG. 7 is an exploded perspective view of the bracket 50 and the radar cover 60.

The bracket 50 is made of a synthetic resin such as acrylic or polycarbonate, and, as shown in FIGS. 6 and 7, includes a bracket main body 51, an upper engagement portion 52, a lower engagement portion 53, and an intermediate engagement portion 54.

The bracket main body 51 includes a radar unit mounting surface 51a and a rear surface 51 b on an opposite side thereof (see FIG. 4). The radar unit mounting surface 51a is provided with screw bosses 51al (three locations) to which the radar unit 70 is screwed (see FIG. 5).

The upper engagement portion 52 (an example of a second engagement portion of the present disclosure) is a portion that engages with an upper engaged portion 61 of the radar cover 60. As shown in FIG. 7, the upper engagement portion 52 is provided on a tip end side in a sliding direction (see arrow Ar2 in FIG. 7) (an upper end side in FIG. 7) of the bracket 50 (the bracket main body 51) corresponding to the upper engaged portion 61 of the radar cover 60. Specifically, as shown in a sectional view taken along line B-B in FIG. 6, the upper engagement portion 52 includes a first extension portion 52a extending forward from the tip end side (an upper end side in FIG. 6) in the sliding direction of the bracket 50 (the bracket main body 51), and a second extension portion 52b extending downward from a tip end portion of the first extension portion 52a. A space S2 into which the upper engaged portion 61 of the radar cover 60 is inserted is formed between the bracket 50 (the bracket main body 51) and the second extension portion 52b (see the sectional view taken along line B-B in FIG. 6).

As shown in the sectional view taken along line B-B (modified example) in FIG. 6, the upper engagement portion 52 may include a first extension portion 52c extending upward from a tip end side (an upper end side in FIG. 6) in a sliding direction of the bracket 50 (the bracket main body 51), and a second extension portion 52d extending forward from a tip end portion of the first extension portion 52 c. A through hole 52d1 into which the upper engaged portion 61 of the radar cover 60 is inserted is formed in the second extension portion 52d (see the sectional view taken along line B-B (modified example) in FIG. 6).

The lower engagement portion 53 (an example of a third engagement portion of the present disclosure) is a portion that engages with a lower engaged portion 62 of the radar cover 60. As shown in FIG. 7, the lower engagement portion 53 is provided on a base end side in a sliding direction (see arrow Ar2 in FIG. 7) (a lower end side in FIG. 7) of the bracket 50 corresponding to the lower engaged portion 62 of the radar cover 60. Specifically, as shown in a sectional view taken along line C-C in FIG. 6, the lower engagement portion 53 is an extension portion extending downward from a base end side (a lower end side in FIG. 6) in the sliding direction of the bracket 50 (the bracket main body 51).

The intermediate engagement portion 54 (an example of a first engagement portion of the present disclosure) is a hook portion that engages with an intermediate engaged portion 63 of the radar cover 60. Hereinafter, it is also referred to as the hook portion 54. As shown in FIG. 7, the hook portion 54 is provided, corresponding to the intermediate engaged portion 63 of the radar cover 60, on both sides and above and below in a sliding direction (see arrow Ar2 in FIG. 7) on a front side of the bracket 50 (the bracket main body 51). The hook portion 54 includes a fixing portion 54a fixed to the front side of the bracket 50 (the bracket main body 51), and an extension portion 54b extending downward from the fixing portion 54a. A recess 54b1 that engages with the intermediate engaged portion 63 (a protrusion) of the radar cover 60 is formed at a tip end portion of the extension portion 54b.

The bracket 50 having the above configuration is detachably attached to the outer lens 30 (the recess 32). Specifically, the bracket 50 is attached to the outer lens 30 or the lamp housing 20 (see FIG. 4) by known fixing means (such as screws or hook portions) with a rear surface of the bracket 50 facing a bottom portion 32b of the recess 32.

Next, the radar cover 60 will be described.

As shown in FIG. 7, the radar cover 60 includes an upper engaged portion 61, a lower engaged portion 62, and an intermediate engaged portion 63.

The upper engaged portion 61 (an example of a second engaged portion of the present disclosure) is a portion with which the upper engagement portion 52 of the bracket 50 engages. As shown in FIG. 7, the upper engaged portion 61 is provided, corresponding to the upper engagement portion 52 of the bracket 50, on a tip end side in a sliding direction (see arrow Ar2 in FIG. 7) (an upper end side in FIG. 7) of the radar cover 60. Specifically, as shown in a sectional view taken along line B-B in FIG. 6, the upper engaged portion 61 is an extension portion extending upward from a tip end side (an upper end side in FIG. 6) in the sliding direction of the radar cover 60.

The lower engaged portion 62 (an example of a third engaged portion of the present disclosure) is a portion with which the lower engagement portion 53 of the bracket 50 engages. As shown in FIG. 7, the lower engaged portion 62 is provided, corresponding to the lower engagement portion 53 of the bracket 50, on a base end side in a sliding direction (see arrow Ar2 in FIG. 7) (a lower end side in FIG. 7) of the radar cover 60. As shown in a sectional view taken along line C-C in FIG. 6, the lower engaged portion 62 includes a first extension portion 62a extending rearward from a base end side (a lower end side in FIG. 6) in the sliding direction of the radar cover 60, and a second extension portion 62b extending upward from a tip end portion of the first extension portion 62a. A space S3 into which the lower engagement portion 53 of the bracket 50 is inserted is formed between the radar cover 60 and the second extension portion 62b (see the sectional view taken along line C-C in FIG. 6).

The intermediate engaged portion 63 (an example of a first engaged portion of the present disclosure) is a portion with which the hook portion 54 (the intermediate engagement portion) of the bracket 50 engages. As shown in FIG. 7, the intermediate engaged portion 63 is provided, corresponding to the hook portion 54 of the bracket 50, on both sides and above and below in a sliding direction (see arrow Ar2 in FIG. 7) of the radar cover 60. Specifically, the intermediate engaged portion 63 is a protrusion with which the hook portion 54 (the recess 54b1) of the bracket 50 engages (see the sectional view taken along line D-D in FIG. 6).

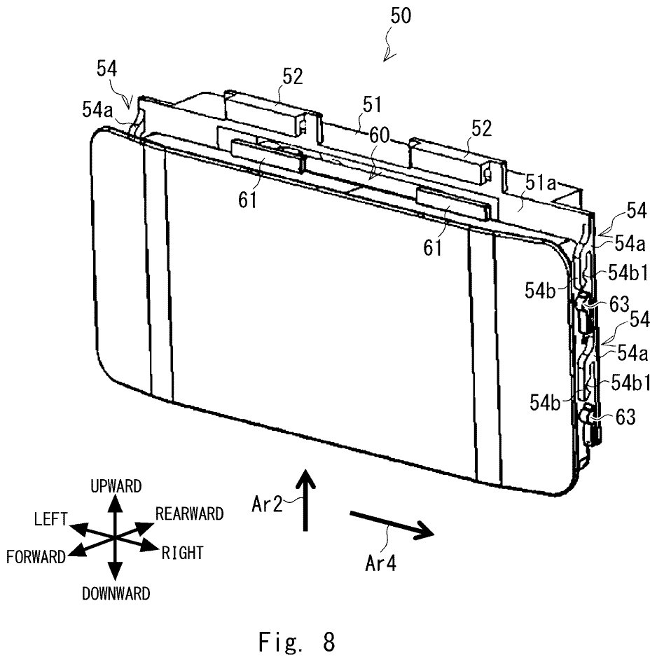

The radar cover 60 having the above configuration is detachably attached to the bracket 50. Specifically, first, as shown in FIG. 8, the radar cover 60 is disposed between hook portions 54 of the brackets 50 on both left and right sides, with a rear surface side of the radar cover 60 abutting against a front surface side (contact surface 51a2; see FIG. 7) of the bracket 50, and with the intermediate engaged portion 63 of the radar cover 60 positioned below the hook portion 54 of the bracket 50. FIG. 8 is a perspective view showing a state in which the rear surface side of the radar cover 60 abuts against the front surface side of the bracket 50, and the intermediate engaged portion 63 of the radar cover 60 is positioned below the hook portion 54 of the bracket 50.

Next, the radar cover 60 arranged as described above is slid in a direction of arrow Ar2 in FIG. 8 with respect to the bracket 50, so that the upper engagement portion 52 of the bracket 50 engages with the upper engaged portion 61 of the radar cover 60 (see the sectional view taken along line B-B in FIG. 6), the lower engagement portion 53 of the bracket 50 engages with the lower engaged portion 62 of the radar cover 60 (see the sectional view taken along line C-C in FIG. 6), and the hook portion 54 of the bracket 50 engages with the intermediate engaged portion 63 (the protrusion) of the radar cover 60 (see the sectional view taken along line D-D in FIG. 6).

Specifically, by the above sliding movement, as shown in a sectional view taken along line B-B in FIG. 6, the upper engaged portion 61 (the extension portion) of the radar cover 60 is inserted into the upper engagement portion 52 (the space S2 between the bracket 50 (the bracket main body 51) and the second extension portion 52b) of the bracket 50. This suppresses rattling of the radar cover 60 in a vehicle front-rear direction. In addition, by the above sliding movement, as shown in a sectional view taken along line C-C in FIG. 6, the lower engagement portion 53 (the extension portion) of the bracket 50 is inserted into the lower engaged portion 62 (the space S3 between the radar cover 60 and the second extension portion 62b) of the radar cover 60. This also suppresses rattling of the radar cover 60 in the vehicle front-rear direction. Further, by the above sliding movement, as shown in a sectional view taken along line D-D in FIG. 6, the hook portion 54 (the recess 54b1) of the bracket 50 engages with the intermediate engaged portion 63 (the protrusion) of the radar cover 60. As a result, the radar cover 60 is detachably attached to the bracket 50 (at a predetermined position).

It is to be noted that the radar cover 60 slides in a direction of arrow Ar2 in FIG. 8 with respect to the bracket 50 along hook portions 54 of the brackets 50 on both left and right sides and a front surface side (contact surface 51a2) of the bracket 50, in a guided manner by the hook portions 54 of the brackets 50 on both left and right sides and the front surface side (the contact surface 51a2) of the bracket 50.

As described above, by the engagement of the engagement portions 52 to 54 of the bracket 50 with the engaged portions 61 to 63 of the radar cover 60, the radar cover 60 is detachably attached to the bracket 50 in a state of being positioned with respect to the bracket 50 in an up-down direction, a front-rear direction, and a left-right direction. At that time, a front-side (left side in FIG. 4) end portion E32cl of the upper inner wall 32cl constituting the recess 32 extends to the radar cover 60, whereas a front-side (left side in FIG. 4) end portion E32c2 of the lower inner wall 32c2 constituting the recess 32 extends to the bracket 50 (see FIG. 4). Therefore, a lower end portion of the radar cover 60 is exposed from the recess 32 without being covered by the lower inner wall 32c2. As a result, the radar cover 60 can be attached to and detached from the bracket 50 in a state where the bracket 50 is attached to the outer lens 30 without removing the bracket 50 from the outer lens 30.

Next, the radar unit 70 will be described.

As shown in FIG. 5, the radar unit 70 (radar device) includes a case 71, and a transmitting antenna, a receiving antenna, and the like (none of which are shown) accommodated in the case 71. The radar unit 70 is a millimeter-wave radar unit that transmits electromagnetic waves (millimeter waves) from the transmitting antenna. The electromagnetic waves (millimeter waves) are transmitted through the radar cover 60 in a range of a vertical spread angle OV (see FIG. 4) and a horizontal spread angle θH (see FIG. 3). The radar unit 70 receives, by the receiving antenna, reflected waves reflected by an object present within the transmission range and transmitted through the radar cover 60. The received signal is subjected to signal processing by a control device, for example, an ECU (Electronic Control Unit) (not shown), and the object (a distance, an angle, and a speed with respect to the object) is detected. In the radar unit 70, for example, millimeter waves in a 76-81 GHz band, particularly millimeter waves in a 79 GHz band, are used, but the frequency band is not limited thereto.

It is to be noted that a radar scheme of the radar unit 70 may be any of a pulse scheme and a CW (Continuous Wave) scheme, or another scheme. In addition, an antenna scheme of the radar unit 70 may be any of a mechanical scanning scheme, a beam switching scheme, a phased array scheme, and a digital forming scheme, or another scheme.

The radar unit 70 having the above configuration is detachably attached to the bracket 50 (the bracket main body 51). Specifically, as shown in FIG. 7, the radar unit 70 is attached to the bracket 50 (the bracket main body 51) by screwing screws N1 (three locations) inserted into flange portions 72 of the radar unit 70 into screw bosses 51al of the radar unit mounting surface 51a of the bracket 50, with a rear surface of the radar unit 70 facing the radar unit mounting surface 51a of the bracket 50.

Next, a procedure for attaching the vehicular lamp 10 having the above configuration to a vehicle body side will be described.

First, the bracket 50 is attached to the outer lens 30 (the recess 32). Specifically, the bracket 50 is detachably attached to the outer lens 30 (the recess 32) by known fixing means (such as screws or hook portions), with a rear surface of the bracket 50 facing a bottom portion 32b of the recess 32.

Next, the vehicular lamp 10 to which the bracket 50 has been attached as described above is attached to the vehicle body side by known fixing means (such as screws).

Next, the radar unit 70 is attached to the bracket 50. Specifically, the radar unit 70 is detachably attached to the bracket 50 (the bracket main body 51) by screwing screws N1 (three locations) inserted into flange portions 72 of the radar unit 70 into screw bosses 51al of the radar unit mounting surface 51a of the bracket 50, with a rear surface of the radar unit 70 facing the radar unit mounting surface 51a of the bracket 50.

Next, the radar cover 60 is attached to the bracket 50. Specifically, first, as shown in FIG. 8, the radar cover 60 is disposed between hook portions 54 of the brackets 50 on both left and right sides, with a rear surface side of the radar cover 60 abutting against a front surface side (contact surface 51a2; see FIG. 7) of the bracket 50, and with the intermediate engaged portion 63 of the radar cover 60 positioned below the hook portion 54 of the bracket 50.

Next, the radar cover 60 arranged as described above is slid in a direction of arrow Ar2 in FIG. 8 with respect to the bracket 50, so that the upper engagement portion 52 of the bracket 50 engages with the upper engaged portion 61 of the radar cover 60 (see the sectional view taken along line B-B in FIG. 6), the lower engagement portion 53 of the bracket 50 engages with the lower engaged portion 62 of the radar cover 60 (see the sectional view taken along line C-C in FIG. 6), and the hook portion 54 of the bracket 50 engages with the intermediate engaged portion 63 (the protrusion) of the radar cover 60 (see the sectional view taken along line D-D in FIG. 6).

At that time, the radar cover 60 slides in a direction of arrow Ar2 in FIG. 8 with respect to the bracket 50 along hook portions 54 of the brackets 50 on both left and right sides and a front surface side (contact surface 51a2) of the bracket 50, in a guided manner by the hook portions 54 of the brackets 50 on both left and right sides and the front surface side (the contact surface 51a2) of the bracket 50.

As described above, by the engagement of the engagement portions 52 to 54 of the bracket 50 with the engaged portions 61 to 63 of the radar cover 60, the radar cover 60 is detachably attached to the bracket 50 in a state of being positioned with respect to the bracket 50 in an up-down direction, a front-rear direction, and a left-right direction.

Next, the bumper 90 is attached to the vehicle body side. Specifically, as shown in FIGS. 1 and 4, the bumper 90 is detachably attached to the vehicle body side by known fixing means (such as screws) in a state of covering a lower side below a lower end portion of the radar cover 60.

As described above, the vehicular lamp 10 is attached to the vehicle body side.

Next, a procedure for removing the radar unit 70 from the bracket 50 will be described. This procedure is executed, for example, when replacing the radar unit 70 in the event of a failure of the radar unit 70, or when rewriting a control program stored in a storage unit such as a ROM incorporated in the radar unit 70 (for example, at the time of a version upgrade).

First, the bumper 90 is removed from the vehicle body side.

Next, the radar cover 60 is removed from the bracket 50.

Specifically, the radar cover 60 is slid in a direction of arrow Ar3 in FIG. 4 with respect to the bracket 50 to release engagement of the upper engagement portion 52 of the bracket 50 with the upper engaged portion 61 of the radar cover 60 (see the sectional view taken along line B-B in FIG. 6), engagement of the lower engagement portion 53 of the bracket 50 with the lower engaged portion 62 of the radar cover 60 (see the sectional view taken along line C-C in FIG. 6), and engagement of the hook portion 54 of the bracket 50 with the intermediate engaged portion 63 (the protrusion) of the radar cover 60 (see the sectional view taken along line D-D in FIG. 6). At that time, the radar cover 60 slides in the direction of arrow Ar3 in FIG. 4 with respect to the bracket 50 along hook portions 54 of the brackets 50 on both left and right sides, in a guided manner by the hook portions 54 of the brackets 50 on both left and right sides.

As described above, the radar cover 60 can be removed from the bracket 50.

Next, the radar unit 70 is removed from the bracket 50 by removing the screws N1 exposed by removing the radar cover 60.

As described above, the radar unit 70 can be removed from the bracket 50.

As described above, according to the present embodiment, by sliding the radar cover 60 in one direction (see arrow Ar2 in FIG. 8) with respect to the bracket 50, it is possible to provide a radar cover attaching/detaching structure capable of detachably attaching the radar cover 60 to the bracket 50. In addition, according to the present embodiment, the radar cover 60 can be attached to and detached from the bracket 50 without using a tool. Further, according to the present embodiment, when attaching and detaching the radar cover 60, since a tool is not used, it is possible to prevent the tool from coming into contact with and damaging surrounding components (for example, the outer lens 30 and the bumper 90). Furthermore, according to the present embodiment, it is possible to reduce variation among operators during attachment and detachment of the radar cover 60.

Next, a modified example will be described.

In the above embodiment, an example has been described in which the upper engagement portion 52, the lower engagement portion 53, and the intermediate engagement portion 54 are provided on the bracket 50, and the upper engaged portion 61, the lower engaged portion 62, and the intermediate engaged portion 63 are provided on the radar cover 60, but the present disclosure is not limited thereto. Conversely, the upper engagement portion 52, the lower engagement portion 53, and the intermediate engagement portion 54 may be provided on the radar cover 60, and the upper engaged portion 61, the lower engaged portion 62, and the intermediate engaged portion 63 may be provided on the bracket 50.

In addition, in the above embodiment, an example has been described in which the radar cover 60 is slid in a direction of arrow Ar2 in FIG. 8 with respect to the bracket 50, but the present disclosure is not limited thereto. For example, the radar cover 60 may be slid with respect to the bracket 50 in another direction, such as a direction of arrow Ar4 in FIG. 8.

In addition, in the above embodiment, an example has been described in which the bumper 90 is used as a vehicle-side member, but the present disclosure is not limited thereto. Various members other than the bumper may be used as the vehicle-side member.

All numerical values shown in the above embodiments are merely examples, and it goes without saying that appropriate numerical values different therefrom may be used.

The above embodiments are merely examples in every respect. The present disclosure is not to be construed in a limited sense by the descriptions of the above embodiments. The present disclosure can be implemented in various other forms without departing from the spirit or essential characteristics thereof.

This application claims priority based on Japanese Patent Application No. 2023-082295 filed on May 18, 2023, the entire disclosure of which is incorporated herein.

### REFERENCE SIGNS LIST

10 . . . VEHICLE LIGHTING FIXTURE
20 . . . LIGHTING FIXTURE HOUSING
30 . . . OUTER LENS
31 . . . LENS PORTION
32 . . . RECESSED PORTION
32a . . . OPENING END PORTION
32b . . . BOTTOM PORTION
32c . . . INNER WALL
32c1 . . . UPPER INNER WALL
32c2 . . . LOWER INNER WALL
32c3 . . . INNER INNER WALL
32c4 . . . OUTER INNER WALL
40 . . . LIGHTING FIXTURE UNIT
50 . . . BRACKET
51 . . . BRACKET MAIN BODY
51a . . . RADAR UNIT MOUNTING SURFACE
51a1 . . . SCREW BOSS
51b . . . REAR SURFACE
52 . . . UPPER ENGAGEMENT PORTION
53 . . . LOWER ENGAGEMENT PORTION
54 . . . HOOK PORTION (INTERMEDIATE ENGAGEMENT PORTION)
54a . . . FIXED PORTION
54b . . . EXTENSION PORTION
54b1 . . . RECESSED PORTION
60 . . . RADAR COVER
61 . . . UPPER ENGAGED PORTION
62 . . . LOWER ENGAGED PORTION
63 . . . INTERMEDIATE ENGAGED PORTION
70 . . . RADAR UNIT
71 . . . CASE
72 . . . FLANGE PORTION
90 . . . BUMPER
E_{32C1}, E_{32C2} . . . END PORTION
N1 . . . SCREW
S1 . . . LAMP

1-6. (canceled)

7. A vehicular lamp comprising:
a housing;
an outer lens attached to a front side of the housing to form a lamp chamber with the housing and having a recess recessed toward the housing;
a bracket detachably attached to the recess; and
a radar unit and a radar cover detachably attached to the bracket,
wherein the bracket and the radar cover include a first engagement portion provided on one of the bracket and the radar cover, and a first engaged portion provided on the other and with which the first engagement portion engages,
wherein the first engagement portion is provided on both sides in a sliding direction on one of the bracket and the radar cover,
wherein the first engaged portion is provided on both sides in the sliding direction on the other of the bracket and the radar cover corresponding to the first engagement portion,
wherein the first engagement portion or the first engaged portion provided on the bracket includes a fixing portion fixed to a front side of the bracket and an extension portion extending downward from the fixing portion,
wherein the first engagement portion engages with the first engaged portion by sliding the radar cover upward relative to the bracket,
wherein the radar cover is detachably attached to the bracket by the first engagement portion engaging with the first engaged portion,
wherein a front-side end portion of an upper inner wall constituting the recess extends to the radar cover, whereas a front-side end portion of a lower inner wall constituting the recess extends to the bracket, and
wherein a lower end portion of the radar cover is exposed from the recess and covered with a vehicle-side member.

8. The vehicular lamp according to claim 7, wherein one of the radar cover and the bracket further includes a second engagement portion and a third engagement portion,
the other of the radar cover and the bracket further includes a second engaged portion with which the second engagement portion engages and a third engaged portion with which the third engagement portion engages,
the second engagement portion is provided on a tip end side in a sliding direction on one of the bracket and the radar cover,
the second engaged portion is provided on a tip end side in the sliding direction on the other of the bracket and the radar cover corresponding to the second engagement portion,
the third engagement portion is provided on a base end side in the sliding direction on one of the bracket and the radar cover, and
the third engaged portion is provided on a base end side in the sliding direction on the other of the bracket and the radar cover corresponding to the third engagement portion.

9. The vehicular lamp according to claim 8, wherein a tip end side in the sliding direction of the radar cover is an upper end side of the radar cover, and
wherein a base end side in the sliding direction of the radar cover is a lower end side of the radar cover.

10. The vehicular lamp according to claim 9, wherein the vehicle-side member is a bumper.
